(19) United States
(12) Patent Application Publication
(10) Pub. No.: US 2015/0324301 A1
(43) Pub. Date: Nov. 12, 2015

(54) STORAGE CONTROL APPARATUS AND COMPUTER-READABLE STORAGE MEDIUM STORING COMPUTER PROGRAM

(71) Applicant: FUJITSU LIMITED, Kawasaki-shi (JP)

(72) Inventors: Wataru Iizuka, Kawasaki (JP); Hidefumi Kobayashi, Yokohama (JP); Yuusuke Oota, Hiratsuka (JP); Atsushi IGASHIRA, Yokohama (JP)

(21) Appl. No.: 14/690,798

(22) Filed: Apr. 20, 2015

(30) Foreign Application Priority Data
May 9, 2014 (JP) 2014-097629

(51) Int. Cl. G06F 12/14

(52) U.S. Cl. CPC G06F 12/1408; G06F 2212/1052

(57) ABSTRACT

A storage unit stores a first control program that includes an encryption program and version information indicating the version number of the encryption program. When backing up configuration data, an operation unit stores encrypted data obtained by encrypting the configuration data, a first part of the encryption program used for the encryption, and the version information in a non-volatile storage medium. After the first control program is updated to a second control program, the operation unit obtains a second part of the encryption program corresponding to the version number registered in the non-volatile storage medium from the second control program, and then generates the encryption program to be used for decrypting the encrypted data stored in the non-volatile storage medium, using the second part and the first part stored in the non-volatile storage medium.

### CROSS-REFERENCE TO RELATED APPLICATION

This application is based upon and claims the benefit of priority of the prior Japanese Patent Application No. 2014-097629, filed on May 9, 2014, the entire contents of which are incorporated herein by reference.

### FIELD

The embodiments discussed herein relate to a storage control apparatus and a computer-readable storage medium storing a computer program.

### BACKGROUND

There have been used storage apparatuses for storing data to be used by users (for example, data to be used in users' business). Data access to the storage apparatuses is controlled by storage control apparatuses. The storage control apparatuses run control programs to control various hardware modules of the storage apparatuses. Control programs for controlling hardware may be called firmware.

For example, a storage control apparatus runs firmware to control data access to storage apparatuses or control the operation of hardware modules provided in a redundant configuration. The storage control apparatus may manage the configuration data of the storage apparatuses and control the storage apparatuses on the basis of the configuration data. To extend or modify the functions of the storage control apparatus, the firmware for it may be updated and distributed by the firmware provider. A user of the storage control apparatus applies the distributed firmware to the storage control apparatus to update the current firmware to the new one.

By the way, data encryption may be used to prevent unauthorized use of data by the third party. For example, there has been proposed a technique of encrypting content and allowing a player, which is to reproduce the content, to obtain decryption software corresponding to the content over a network.

In addition, there has been proposed another technique of encrypting a mail protection program, which is used for encrypting and decrypting electronic mails, dividing the encrypted program into halves, and storing these divided parts in separate processors. In this proposal, one of the divided parts of the encrypted mail protection program is transferred to one of these processors, which is to run a decryption program, and is combined with the other part, and then the resultant is decrypted with the decryption program.

Please see, for example, Japanese Laid-open Patent Publications Nos. 2007-25768 and 2003-114853.

Configuration data to be used by the control program (for example, firmware) of a storage control apparatus may include important information for access to a storage area of a storage apparatus. To enhance security against unauthorized access to the storage apparatus, there is an idea of including an encryption program for encrypting and decrypting configuration data in the control program, and encrypting the configuration data with the encryption program at the time of backing up the configuration data. The security may be further enhanced by occasionally updating the encryption method using the encryption program. However, there arises a problem of how to distribute the control program.

For example, if a previous version of the encryption program is not supported by an updated control program, it is not possible to decrypt data that has been encrypted with the previous version of the encryption program. If all previous versions of the encryption program are included in full in the control program, the data size of the control program increases each time the encryption program is updated.

### SUMMARY

According to one aspect, there is provided a storage control apparatus that includes: a memory that stores a first control program to be used for controlling a storage apparatus, the first control program including an encryption program to be used for encrypting and decrypting data and version information indicating a version number of the encryption program; and a processor that performs a process including: storing, when backing up the data, encrypted data obtained by encrypting the data, a first part of the encryption program used for the encrypting, and the version information in a non-volatile storage medium; obtaining, when reading the encrypted data from the non-volatile storage medium after the first control program is updated to a second control program, a second part of the encryption program corresponding to the version number indicated by the version information stored in the non-volatile storage medium from the second control program; and generating the encryption program to be used for decrypting the encrypted data stored in the non-volatile storage medium, using the obtained second part and the first part stored in the non-volatile storage medium.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a storage control apparatus according to a first embodiment;

FIG. 2 illustrates an information processing system according to a second embodiment;

FIG. 3 illustrates exemplary hardware of a storage apparatus according to the second embodiment;

FIG. 4 illustrates exemplary hardware of a server according to the second embodiment;

FIG. 5 illustrates an example of functions according to the second embodiment;

FIG. 6 illustrates an example of a management table according to the second embodiment;

FIG. 7 illustrates an example of a segment table according to the second embodiment;

FIGS. 8A and 8B illustrate an example of program segments according to the second embodiment;

FIG. 9 is a flowchart illustrating an example of encryption according to the second embodiment;

FIG. 10 is a flowchart illustrating an example of decryption according to the second embodiment;

FIG. 11 illustrates a specific example of an encryption process according to the second embodiment;

FIGS. 12A and 12B illustrate an example of firmware comparison;

FIG. 13 illustrates an example of tables according to a third embodiment;

FIG. 14 is a flowchart illustrating an example of how to create a management table according to the third embodiment;

FIG. 15 is a flowchart illustrating an example of encryption according to the third embodiment;

FIG. 16 is a flowchart illustrating an example of decryption according to the third embodiment; and

FIG. 17 illustrates a specific example of restoring an encryption program according to the third embodiment.

### DESCRIPTION OF EMBODIMENTS

Several embodiments will be described below with reference to the accompanying drawings, wherein like reference numerals refer to like elements throughout.

### First Embodiment

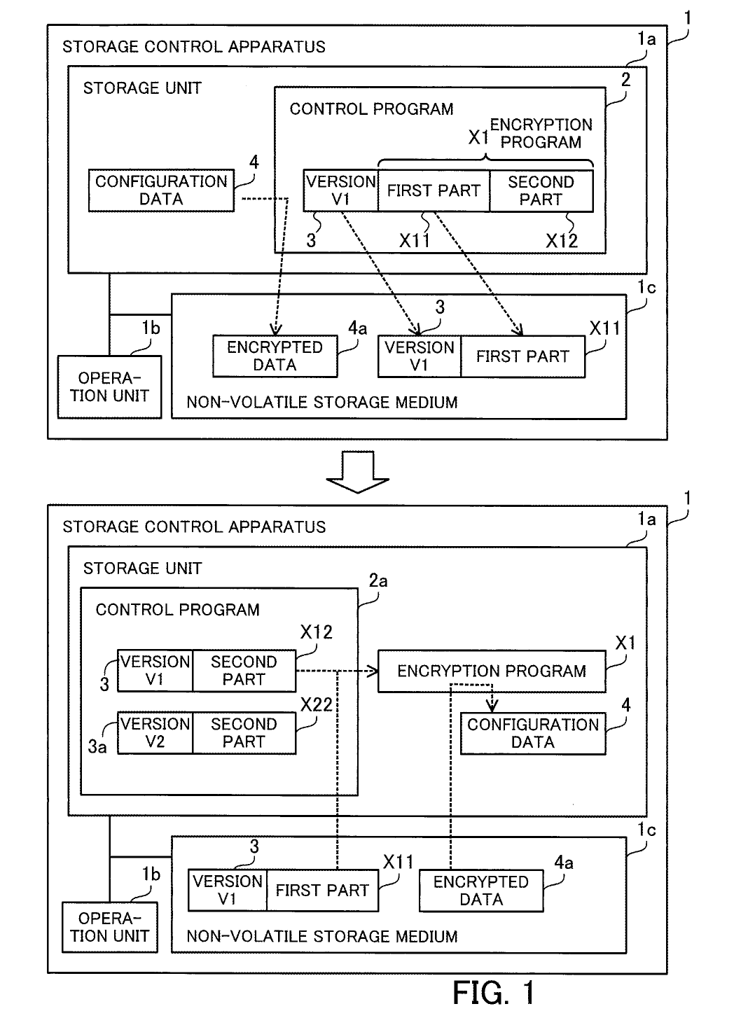

FIG. 1 illustrates a storage control apparatus according to a first embodiment. A storage control apparatus 1 is designed to control data access to a storage apparatus (not illustrated) or to control the operation of hardware modules installed in the storage apparatus and storage control apparatus 1. The storage apparatus includes, for example, a plurality of Hard Disk Drives (HDD), Solid State Drives (SSD), and the like, to provide relatively large capacity storage. The storage control apparatus 1 may be provided internal or external to the storage apparatus.

The storage control apparatus 1 includes a storage unit 1a, an operation unit 1b, and a non-volatile storage medium 1c. The storage unit 1a is a volatile storage device, such as a Random Access Memory (RAM).

The operation unit 1b may be a Central Processing Unit (CPU), a Digital Signal Processor (DSP), an Application Specific Integrated Circuit (ASIC), a Field Programmable Gate Array (FPGA), or the like. The operation unit 1b may be a processor that runs programs. The “processor” here may be a plurality of processors (multiprocessor).

The non-volatile storage medium 1c may be an HDD, SSD, magnetic tape, optical disc, or the like. The non-volatile storage medium 1c may be provided in the storage control apparatus 1 or the storage apparatus. The non-volatile storage medium 1c having data contained therein may be detached from the storage control apparatus 1 or the storage apparatus and may be kept separately (for example, a magnetic tape, optical disc, or the like).

The storage unit 1a stores a control program 2 (first control program) and configuration data 4 to be used for processing by the control program 2. The control program 2 is software to be used for controlling storage apparatuses (including a storage apparatus provided internal or external to the storage control apparatus 1). The control program 2 may be called firmware. The control program 2 may be stored in a non-volatile storage device, such as a flash memory, provided in the storage control apparatus 1. The operation unit 1b loads the control program 2 from the non-volatile storage device to the storage unit 1a and then runs the control program 2.

The control program 2 includes an encryption program X1 to be used for encrypting and decrypting data and version information 3 indicating the version number of the encryption program X1. For example, the version information 3 indicates a version number V1. The version number of the encryption program X1 is the version V1. For example, the encryption program X1 is used for encrypting and decrypting the configuration data 4.

When backing up data, the operation unit 1b stores the data encrypted, a first part of the encryption program used for the encryption, and the version information of the encryption program in the non-volatile storage medium 1c. For example, when backing up the configuration data 4, the operation unit 1b encrypts the configuration data 4 with the encryption program X1 to thereby generate encrypted data 4a. The configuration data 4 is backed up each time, for example, the storage control apparatus 1 shuts down, so that the configuration data 4 becomes available when the storage control apparatus 1 starts up next time.

The encrypted data 4a is the encrypted data of the configuration data 4. The operation unit 1b stores the encrypted data 4a, the first part X11 of the encryption program X1, and the version information 3 of the encryption program X1 in the non-volatile storage medium 1c. A second part X12 of the encryption program X1 is the remaining part other than the first part X1.

The operation unit 1b updates the control program 2, which is used for controlling the operation of the storage control apparatus, to a control program 2a (second control program). That is to say, the operation unit 1b stores the control program 2a in the storage unit 1a, in place of the control program 2, and then runs the control program 2a. The control program 2a is newer than the control program 2. If the configuration data 4 is obtained by decrypting the encrypted data 4a stored in the non-volatile storage medium 1c, the configuration of the storage apparatus may remain unchanged before and after the update of the control program.

In this connection, the control program 2a includes only part (second part) of each previous version of the encryption program in association with its version number, and does not include each previous version of the encryption program in full. For example, the control program 2a includes the second part X12 in association with the version information 3 indicating a previous version number (i.e., the version number V1), and also includes a second part X22 in association with version information 3a indicating a previous version number (i.e., a version number V2). The control program 2a may include, in full, a newer version (for example, the latest version) of the encryption program than the versions V1 and V2. The operation unit 1b decrypts the encrypted data 4a in the following manner.

When reading data from the non-volatile storage medium 1c after the control program 2 is updated to the control program 2a, the operation unit 1b obtains the second part of the encryption program corresponding to the version number registered in the non-volatile storage medium 1c, from the control program 2a. For example, in the case where the version information 3 indicating the version number V1 is stored in the non-volatile storage medium 1c, the operation unit 1b obtains the second part X12 corresponding to the version number V1 from the control program 2a.

The operation unit 1b generates an encryption program to be used for decrypting the data stored in the non-volatile storage medium 1c, using the obtained second part and the first part stored in the non-volatile storage medium 1c. For example, the operation unit 1b generates the encryption program X1 using the obtained second part X12 and the first part X11 stored in the non-volatile storage medium 1c. The encryption program X1 is used for decrypting the encrypted data 4a. The operation unit 1b decrypts the encrypted data 4a with the encryption program X1 to thereby obtain the configuration data 4.

In the above-described storage control apparatus 1, at the time of backing up the configuration data 4, the encrypted data 4a, the first part X11 of the encryption program X1 used for the encryption, and the version information 3 (version number V1) of the encryption program X1 are stored in the non-volatile storage medium 1c. When the encrypted data 4a is read from the non-volatile storage medium 1c after the control program 2 is updated to the control program 2a, the second part X12 of the encryption program X1 corresponding to the version number V1 registered in the non-volatile storage medium 1c is obtained from the control program 2a. The encryption program X1 to be used for decrypting the encrypted data 4a stored in the non-volatile storage medium 1c is generated using the second part X12 and the first part X11 stored in the non-volatile storage medium 1c. This approach reduces the data size of the control program.

Now, consider the case of, for example, including the encryption program X1 corresponding to the previous version number V1 and the encryption program corresponding to the previous version number V2 in the control program 2a, in full. In this case, the data size of the control program increases each time the encryption program is updated. In addition, if the encryption program X1 is stored in full in the non-volatile storage medium 1c, there is a risk that the third party is able to decrypt the encrypted data 4a by simply obtaining the non-volatile storage medium 1c, which degrades the security.

By contrast, the storage control apparatus 1 is designed to include only part of a previous encryption program in the new control program 2a. By doing so, the storage control apparatus 1 is able to decrypt data (for example, encrypted data 4a) that has been encrypted with the previous encryption program even after the control program is updated to the control program 2a. Therefore, the control program 2a has a small data size, compared with the case where the control program 2a contains the versions V1, V2, . . . of the encryption program in full.

Especially, it is preferable that the data size of the first part (for example, first part X11) is larger than that of the second part (for example, second part X12). This is because the data size of the control program 2a may be further reduced by including the second part of smaller data size in the control program 2a.

Further, the encryption program X1 is not stored in full in the non-volatile storage medium 1c. This reduces the risk that the third party obtains the non-volatile storage medium 1c and decrypts the encrypted data 4a to fraudulently use the configuration data 4.

### Second Embodiment

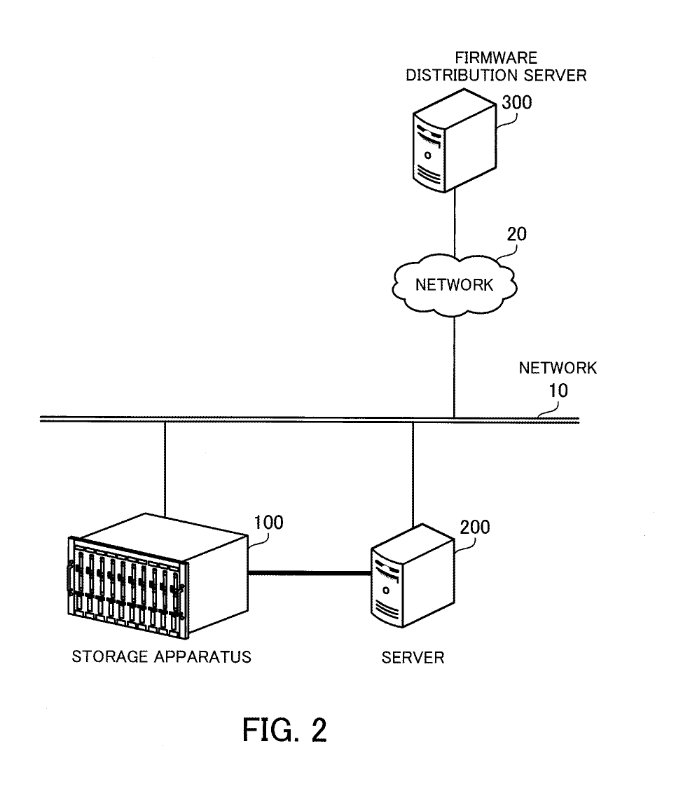

FIG. 2 illustrates an information processing system according to a second embodiment. An information processing system of the second embodiment includes a storage apparatus 100, a server 200, and a firmware distribution server 300. The storage apparatus 100 and the server 200 are connected to each other with cables, such as Serial Attached SCSI (SAS) or Fibre Channel (FC). Such a connection system may be called a Direct Attached Storage (DAS). Alternatively, the storage apparatus 100 and the server 200 may be connected to each other over a Storage Area Network (SAN) using Fibre Channel, Internet Small Computer System Interface (iSCSI), etc. The storage apparatus 100 may be used as Network Attached Storage (NAS).

The storage apparatus 100 and the server 200 are connected to a network 10. The network 10 is a Local Area Network (LAN) for management and is connected to a wide-area network 20, such as the Internet.

The storage apparatus 100 stores user data to be used for processing by the server 200. The storage apparatus 100 runs firmware to control the operation of locally installed hardware modules. The storage apparatus 100 has a function of encrypting and backing up configuration data to be used for processing by the firmware.

The server 200 is a server computer that accesses the user data in the storage apparatus 100.

The firmware distribution server 300 is a server computer that distributes firmware to be used by the storage apparatus 100 to the storage apparatus 100 or server 200. The firmware may be updated for function extension and program modification. When the firmware is updated, the firmware distribution server 300 distributes the updated firmware.

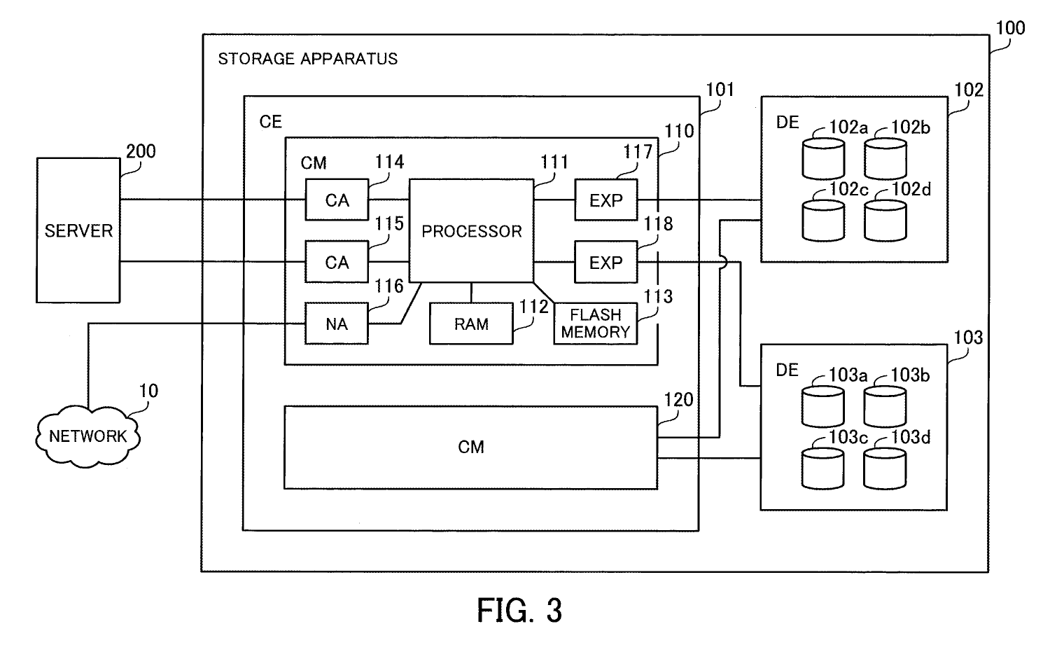

FIG. 3 illustrates exemplary hardware of a storage apparatus according to the second embodiment. The storage apparatus 100 includes a Controller Enclosure (CE) 101 and Drive Enclosures (DE) 102 and 103. The CE 101 includes Controller Modules (CM) 110 and 120. The CMs 110 and 120 are storage control apparatuses that control data access to the DEs 102 and 103 and control the operation of hardware modules of the storage apparatus 100. In this example, the CMs 110 and 120 (storage control apparatuses) are implemented in the storage apparatus 100. The CE 101 may be considered as a storage control apparatus. As separate devices, the DEs 102 and 103 may be provided external to the CMs 110 and 120 (or CE 101).

The CMs 110 and 120 are made redundant within the CE 101. Various hardware modules in the CM 110 are also made redundant within the CM 110. The same applies to the CM 120.

The CM 110 includes a processor 111, a RAM 112, a flash memory 113, Channel Adapters (CA) 114 and 115, a network adapter (NA) 116, and Expanders (EXPs) 117 and 118.

The processor 111 controls the information processing performed by the CM 110. The processor 111 may be a multiprocessor. The processor 111 may be a CPU, DSP, ASIC, FPGA, or the like, for example. The processor 111 may be a combination of two or more selected from a CPU, DSP, ASIC, FPGA, and so on.

The RAM 112 is a main memory device of the CM 110. The RAM 112 temporarily stores at least part of the program for the firmware to be run by the processor 111.

The flash memory 113 is an auxiliary memory device of the CM 110. The flash memory 113 is a non-volatile semiconductor memory, and stores the program for the firmware and others.

The CAs 114 and 115 are communication interfaces for communication with the server 200. The CAs 114 and 115 are made redundant.

The NA 116 is a communication interface for communication with the firmware distribution server 300 over the network 10. The CM 110 may be provided with a plurality of NAs.

The EXPs 117 and 118 are communication interfaces for access to the DEs 102 and 103. The EXPs 117 and 118 are connected to the DEs 102 and 103, respectively.

The CM 120 may be implemented with the same hardware as the CM 110. The CM 120 is connected to the DEs 102 and 103 as well. In addition, the CM 120 is connected to the server 200 and network 10 (not illustrated).

Each DE 102, 103 includes a plurality of HDDs (magnetic disk device) to provide large capacity storage. The DE 102 includes HDDs 102a, 102b, 102c, and 102d. The DE 103 includes HDDs 103a, 103b, 103c, and 103d. Each DE 102, 103 may be provided with another non-volatile storage medium, such as SSD, in place of or in addition to the HDDs. For example, each CM 110, 120 is able to provide a logical storage area where access performance and fault tolerance are secured with the Redundant Array of Inexpensive Disks (RAID) technology using the plurality of HDDs provided in the DEs 102 and 103.

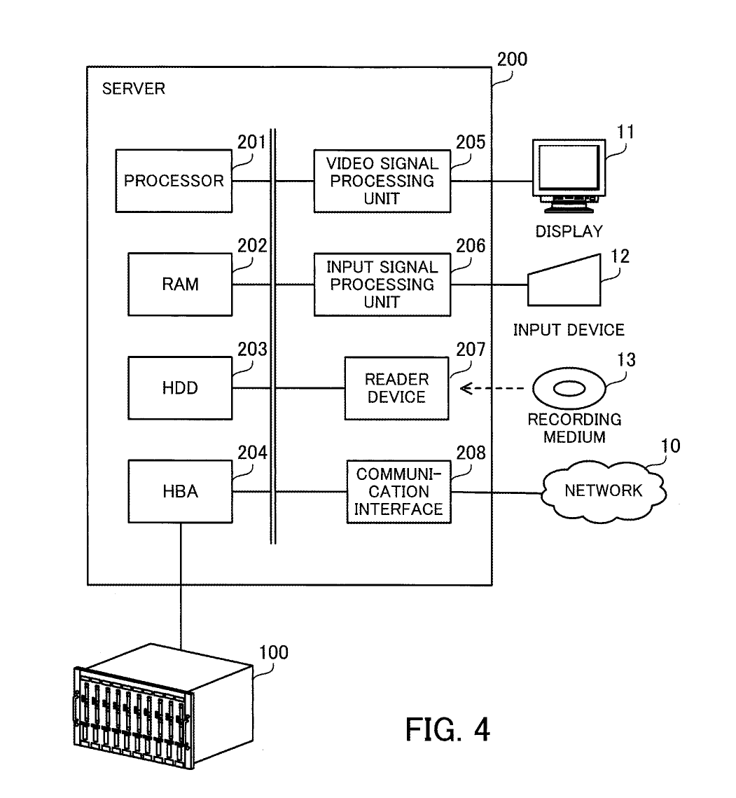

FIG. 4 illustrates exemplary hardware of a server according to the second embodiment. The server 200 includes a processor 201, a RAM 202, an HDD 203, a Host Bus Adapter (HBA) 204, a video signal processing unit 205, an input signal processing unit 206, a reader device 207, and a communication interface 208. The firmware distribution server 300 may also be implemented with the same hardware configuration as the server 200.

The processor 201 may be a multiprocessor. The processor 201 may be, for example, a CPU, a DSP, an ASIC, or an FPGA. The processor 201 may be a combination of two or more selected from a CPU, a DSP, an ASIC, an FPGA, and the like.

The RAM 202 is a main memory device of the server 200. The RAM 202 temporarily stores at least part of Operating System (OS) programs and application programs to be run by the processor 201. The RAM 202 also stores various data to be used for processing by the processor 201.

The HDD 203 is an auxiliary memory device of the server 200. The HDD 203 magnetically performs data read and write on a built-in magnetic disk. The HDD 203 stores OS programs, application programs, and various data. The server 200 may be provided with another kind of auxiliary memory device, such as a flash memory or an SSD, or with a plurality of auxiliary memory devices.

The HBA 204 is a communication interface to be used for performing data read and write on the storage apparatus 100. Communication with the storage apparatus 100 may be performed using, for example, SAS, FC or the like.

The video signal processing unit 205 outputs images to a display 11 connected to the server 200 in accordance with instructions from the processor 201. As the display 11, a Cathode Ray Tube (CRT) display, a crystal liquid display, or another may be used.

The input signal processing unit 206 transfers an input signal received from an input device 12 connected to the server 200, to the processor 201. As the input device 12, a pointing device, such as a mouse or a touch panel, a keyboard, or the like may be used.

The reader device 207 reads programs or data from a recording medium 13. As the recording medium 13, for example, a magnetic disk, such as a Flexible Disk (FD) or an HDD, an optical disc, such as a Compact Disc (CD) or a Digital Versatile Disc (DVD), or a Magneto-Optical disk (MO) may be used. As the recording medium 13, for example, a non-volatile semiconductor memory, such as a flash memory card, may be used. The reader device 207 stores programs and data read from the recording medium 13 in the RAM 202 or HDD 203 in accordance with, for example, instructions from the processor 201. Further, the processor 201 may instruct the storage apparatus 100 to store programs and data read from the recording medium 13 in the RAM 112 or flash memory 113 of the storage apparatus 100.

The communication interface 208 performs communication with other computers including the firmware distribution server 300 over the network 10.

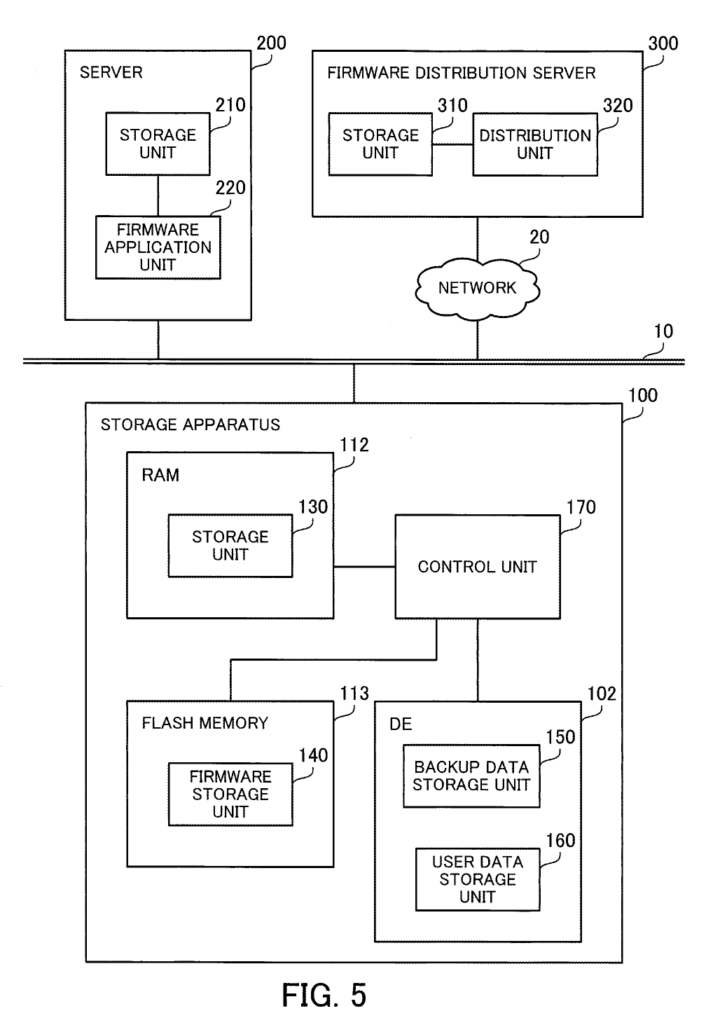

FIG. 5 illustrates an example of functions according to the second embodiment. The storage apparatus 100 includes a storage unit 130, a firmware storage unit 140, a backup data storage unit 150, a user data storage unit 160, and a control unit 170.

The storage unit 130 may be implemented as a storage area prepared in the RAM 112. The storage unit 130 temporarily stores the program for the firmware and configuration data to be used for processing by the firmware. The firmware contains an encryption program for encrypting and decrypting configuration data. The firmware also includes information on a key to be used in the encryption program. Since the RAM 112 is a volatile storage device, information stored in the storage unit 130 is deleted when the storage apparatus 100 (or CM 110) shuts down (when power is turned off).

The firmware storage unit 140 may be implemented as a storage area prepared in the flash memory 113. Since the flash memory 113 is a non-volatile storage device, information stored in the firmware storage unit 140 remains even when the storage apparatus 100 (or CM 110) shuts down.

The firmware storage unit 140 stores the program for the firmware. For example, the processor 111 loads the program for the firmware from the firmware storage unit 140 to the storage unit 130 and runs the program for the firmware, so that the functions of the firmware are implemented on the storage apparatus 100.

Information in the firmware storage unit 140 is rewritable. When the firmware is updated, the updated firmware is stored in the firmware storage unit 140. The aforementioned encryption program may be updated when the firmware is updated. By rebooting the storage apparatus 100 (or the CM 110) after the updated firmware is stored in the firmware storage unit 140, the firmware stored in the storage unit 130 may be updated to the new one.

The backup data storage unit 150 is implemented as a storage area prepared in the HDD of the DE 102. Since the HDD is a non-volatile storage device, information in the backup data storage unit 150 remains even when the storage apparatus 100 shuts down.

The backup data storage unit 150 stores configuration data to be used for processing by the firmware. In this connection, the configuration data is encrypted and then is stored in the backup data storage unit 150, as will be described later. For example, when the storage apparatus 100 (or the CM 110) shuts down, the configuration data stored in the storage unit 130 is encrypted and then is saved in the backup data storage unit 150. By doing so, when the storage apparatus 100 (or the CM 110) starts up next time, the encrypted configuration data may be read from the backup data storage unit 150. By decrypting the configuration data with the encryption program included in the firmware and using the decrypted configuration data, the configuration prior to the rebooting may be applied after the rebooting.

The user data storage unit 160 is implemented as a storage area prepared in the HDD of the DE 102. The user data storage unit 160 stores user data to be used in user's business processing. The DE 103 also includes a user data storage unit.

The control unit 170 manages the operational status of the firmware and controls the updating of the firmware. The control unit 170 may be implemented, by the processor 111 executing a different program from the firmware or as part of the functions of the firmware.

When the storage apparatus 100 or the CM 110 shuts down, the control unit 170 saves the configuration data stored in the storage unit 130 to the backup data storage unit 150. Before the saving, the control unit 170 encrypts the configuration data with the encryption program included in the firmware.

The configuration data includes information to be used for data access to the DEs 102 and 103. Saving encrypted configuration data in the backup data storage unit 150 makes it difficult to access and use the encrypted configuration data. Therefore, the configuration data is encrypted in order to reduce unauthorized access to user data stored in the DEs 102 and 103.

In addition to saving the encrypted configuration data, the control unit 170 saves part (program segment) of the encryption program used for the encryption in association with the version number of the encryption program in the backup data storage unit 150. Then, when the storage apparatus 100 or the CM 110 starts up, the control unit 170 decrypts the encrypted configuration data stored in the backup data storage unit 150 and stores the resultant in the storage unit 130. This allows the storage apparatus 100 to have the same configuration as before the shutdown. A method of decrypting encrypted configuration data will be described in detail later.

The server 200 includes a storage unit 210 and a firmware application unit 220. The storage unit 210 is implemented as a storage area prepared in the RAM 202 or the HDD 203. The storage unit 210 stores the program for the firmware of the storage apparatus 100 received from the firmware distribution server 300. The firmware application unit 220 receives the latest version of the program for the firmware from the firmware distribution server 300 and applies the program to the storage apparatus 100. In this connection, the storage apparatus 100 may directly obtain the latest version of the program for the firmware from the firmware distribution server 300 (not via the server 200).

The firmware distribution server 300 includes a storage unit 310 and a distribution unit 320. The storage unit 310 is implemented as a storage area prepared in the RAM or HDD of the firmware distribution server 300. The storage unit 310 stores the program for the firmware. The distribution unit 320 distributes the program for the firmware stored in the storage unit 310.

The firmware stored in the storage unit 310 includes the following information regarding the latest and previous encryption programs: (1) the latest version of the encryption program in full; and (2) Part (program segment) of the previous versions of the encryption program.

As described earlier, the control unit 170 may be implemented as a program module to be executed by the processor 111. In addition, the CM 120 has the same functions as the storage unit 130, firmware storage unit 140, backup data storage unit 150, and control unit 170 and may perform the same processing as the CM 110. Further, the firmware application unit 220 may be implemented as a program module to be executed by the processor 201. The distribution unit 320 may be implemented as a program module to be executed by the processor of the firmware distribution server 300.

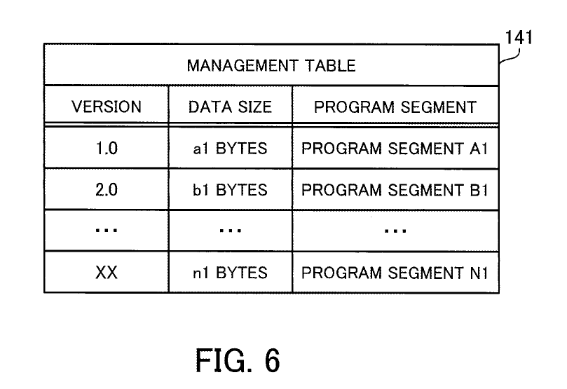

FIG. 6 illustrates an example of a management table according to the second embodiment. A management table 141 is information that is distributed together with a program for firmware by the firmware distribution server 300. The management table 141 is incorporated in the firmware, for example, and is stored in the firmware storage unit 140 together with the program for firmware. The management table 141 includes fields for “version,” “data size,” and “program segment.”

The “version” field indicates the version number of the encryption program. The “data size” field indicates the size of a program segment. The “program segment” field contains the program segment. The program segment is, for example, part of the encryption program in binary form. In the following description, a program segment is represented like “program segment A1.”

For example, the management table 141 includes a record with a version of “1.0,” a data size of “a1 bytes,” and a program segment of “program segment A1.” This record indicates that the program segment A1 of the version “1.0” of the encryption program is contained in the management table 141 and the program segment A1 has a data size of a1 bytes.

With respect to each of the latest and previous versions of the encryption program, the management table 141 indicates the version number and data size, and contains a program segment. In this connection, the contents of the program segment of the latest version of the encryption program may not be registered (with respect to the latest version, only the version number and the data size of the program segment may be registered).

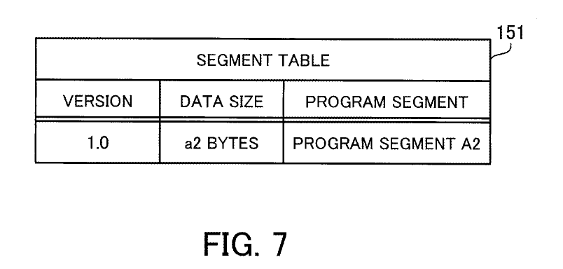

FIG. 7 illustrates an example of a segment table according to the second embodiment. A segment table 151 is created by the control unit 170 and is stored in the backup data storage unit 150. The segment table 151 includes fields for “version,” “data size,” and “program segment.”

The “version” field indicates the version number of the encryption program used for encryption. The “data size” field indicates the size of a program segment. The “program segment” field contains the program segment.

For example, the segment table 151 includes a record with a version of “1.0,” a data size of “a2 bytes,” and a program segment of “program segment A2.” This record indicates that the program segment A2 of the version 1.0 of the encryption program is contained in the segment table 151 and the program segment A2 has a data size of a2 bytes.

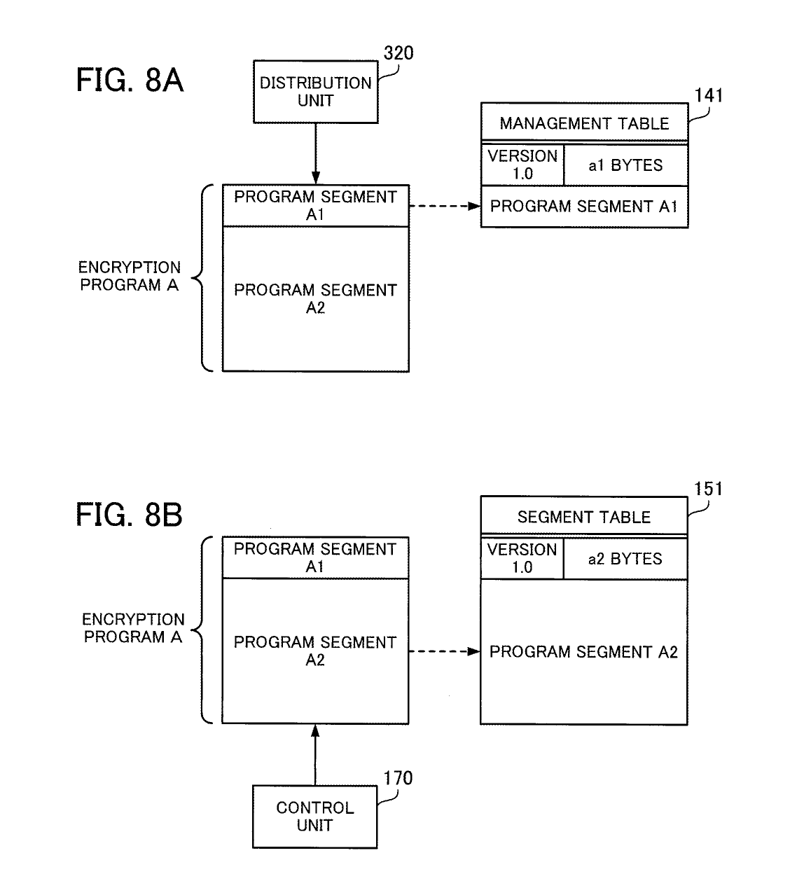

FIGS. 8A and 8B illustrate an example of program segments according to the second embodiment. FIG. 8A exemplifies how to create a program segment A1. FIG. 8B exemplifies how to create a program segment A2. The program segment A1 is part of an encryption program A, whereas the program segment A2 is the remaining part other than the program segment A1 of the encryption program A. For example, the program segment A1 is the part of a1 bytes from the beginning of the encryption program A (former part), and the program segment A2 is the remaining part of a2 bytes (latter part). In this case, the encryption program A is restored by connecting the program segment A2 to the end of the program segment A1.

The program segment A1 is generated from the encryption program A by the distribution unit 320 and is registered in the management table stored in the storage unit 310. With respect to previous versions of the encryption program, the distribution unit 320 registers their program segments in association with their sizes and version numbers in the management table in the same way. The management table is included in the latest version of the firmware and then is distributed.

The program segment A2 is generated from the encryption program A by the control unit 170 and is registered in the segment table 151. At this time, the program segment A2 is generated such that its size a2 is larger than the size a1 of the program segment A1. This is to minimize an increase in the data size of the management table to be included in the firmware and thus in the size of the firmware to be distributed. In this example, the beginning part is taken as the program segment A1, but this may be treated as the program segment A2. The program segment A2 is an example of the first part X11 described in the first embodiment, whereas the program segment A1 is an example of the second part X12 described in the first embodiment.

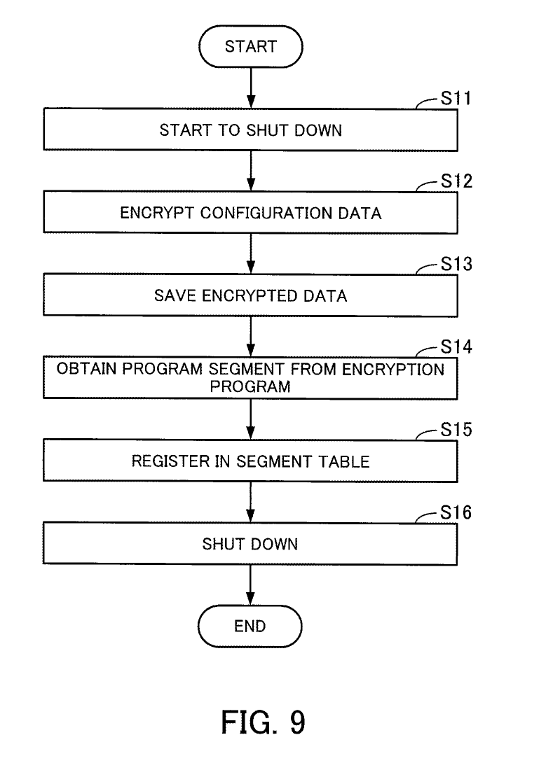

FIG. 9 is a flowchart illustrating an example of encryption according to the second embodiment. The process of FIG. 9 will be described step by step.

(S11) The CM 110 starts to shut down. The control unit 170 may control the shutdown of the CM 110.

(S12) The control unit 170 encrypts configuration data stored in the storage unit 130 with the latest version of the encryption program included in the currently running firmware. By way of example, it is assumed that the version “1.0” of the encryption program A is used for this encryption. In addition, the encrypted configuration data is referred to as encrypted data.

(S13) The control unit 170 stores the encrypted data in the backup data storage unit 150 (save the encrypted data).

(S14) The control unit 170 obtains the program segment A2 by dividing the encryption program A. More specifically, the control unit 170 recognizes the data size, “a1 bytes,” of the program segment A1 with reference to the management table 141. The control unit 170 then takes the remaining part of the encryption program A, other than the beginning part of “a1 bytes,” as the program segment A2.

(S15) The control unit 170 registers the version number “1.0” of the encryption program A, the data size “a2 bytes” of the program segment A2, and the contents of the program segment A2 in the segment table 151 stored in the backup data storage unit 150.

(S16) The CM 110 completes its shutdown. In the case where the program for the firmware is updated, the shutdown is completed after the updated program for the firmware is stored in the firmware storage unit 140 in the flash memory 113.

As described above, when the CM 110 shuts down (power is turned off), the control unit 170 encrypts the configuration data stored in the RAM 112 and saves the resultant in the backup data storage unit 150 for backup. At this time, the control unit 170 registers the program segment A2 of the encryption program A used for encrypting the configuration data in the segment table 151.

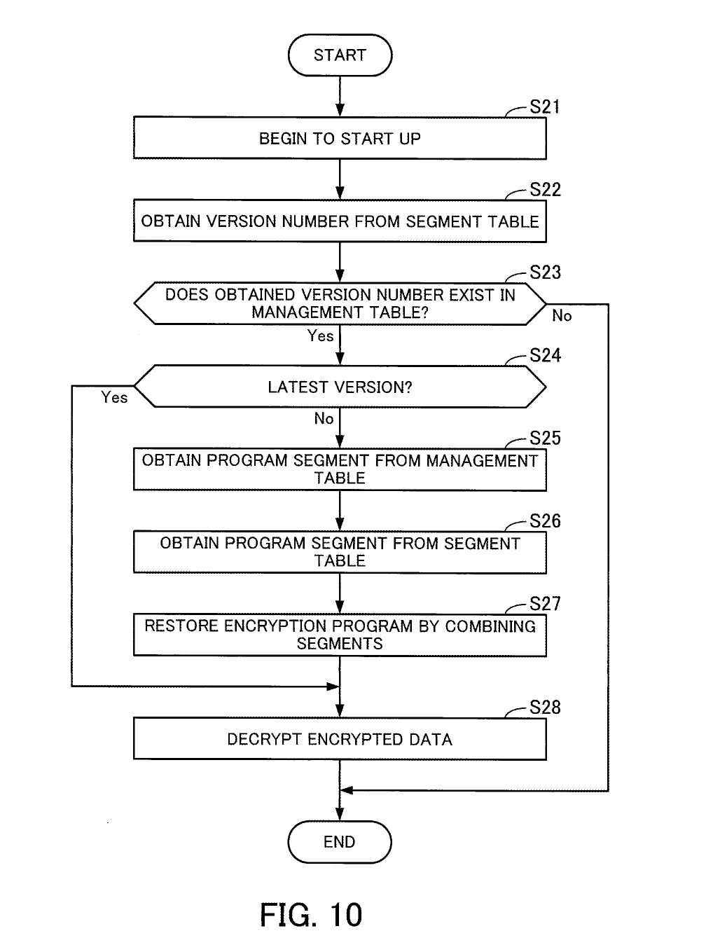

FIG. 10 is a flowchart illustrating an example of decryption according to the second embodiment. The process of FIG. 10 will be described step by step.

(S21) The CM 110 begins to start up. For example, the processor 111 loads a program describing the functions of the control unit 170 and the program for the firmware from the flash memory 113 to the RAM 112, and runs the loaded programs to implement the control unit 170 and the functions of the firmware on the CM 110. At this time, the program for the firmware read from the RAM 112 may be an updated version of the program for the firmware used at the time of the last shutdown. If so, the encryption program may also have been updated.

(S22) The control unit 170 obtains the version number of the program segment with reference to the segment table 151. For example, the control unit 170 obtains the version number “1.0” of the program segment A2 with reference to the segment table 151.

(S23) The control unit 170 determines whether the version number obtained at step S22 exists in the management table 141. If this version number exists, the process proceeds to step S24. Otherwise, the process is completed. If the version number obtained at step S22 does not exist, it means that it is not possible to decrypt the encrypted data stored in the backup data storage unit 150. In this case, the control unit 170 may notify the user of the error.

(S24) The control unit 170 determines whether the version number obtained at step S22 is the latest version. If it is the latest version, the process proceeds to step S28. Otherwise, the process proceeds to step S25. As described earlier, the latest version of the encryption program is included in full in the firmware. For example, in the case where the version number “1.0” is the latest version, the encryption program A is included in full in the firmware loaded in the RAM 112.

(S25) The control unit 170 obtains the program segment corresponding to the version number obtained at step S22 from the management table 141. For example, the management table 141 has been loaded together with the firmware to the storage unit 130. In the case of the version number “1.0,” the control unit 170 obtains the program segment A1 from the management table 141.

(S26) The control unit 170 obtains the program segment A2 from the segment table 151.

(S27) The control unit 170 restores the encryption program A by combining the program segments A1 and A2.

(S28) The control unit 170 decrypts the encrypted data stored in the backup data storage unit 150 with the encryption program A to thereby obtain the configuration data.

As described above, the control unit 170 restores the encryption program A and decrypts the encrypted data to thereby obtain the configuration data. Thereby, the control unit 170 is able to control the storage apparatus 100 using the obtained configuration data.

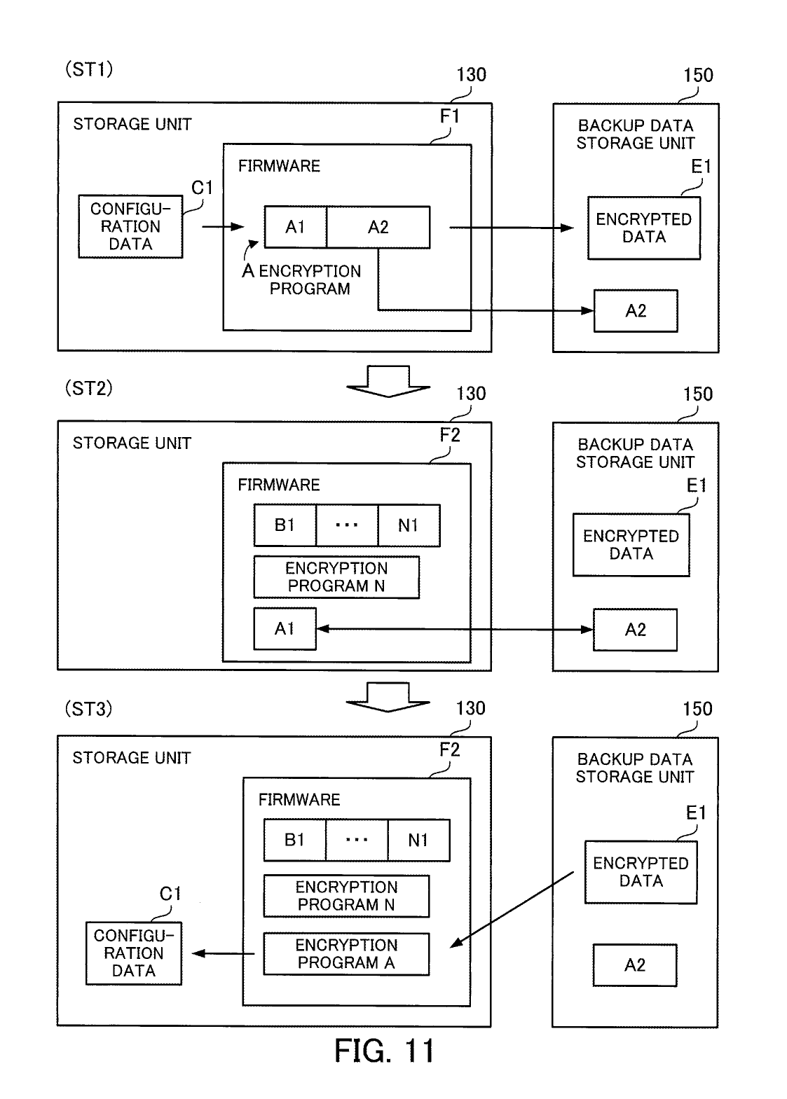

FIG. 11 illustrates a specific example of an encryption process according to the second embodiment. In the example of FIG. 11, configuration data C1 and firmware F1 are stored in the storage unit 130. In the firmware F1, the encryption program A is of the latest version. The control unit 170 encrypts the configuration data C1 with the encryption program A to thereby generate encrypted data E1. The control unit 170 then stores the encrypted data E1 in the backup data storage unit 150 (DE 102). The control unit 170 also obtains the program segment A2 from the encryption program A and then stores the program segment A2 in association with the version number “1.0” of the encryption program A in the backup data storage unit 150 (step ST1).

Then, the firmware F1 is replaced with firmware F2. In the firmware F2, an encryption program N is of the latest version. The firmware F2 contains only part of previous versions of the encryption program to the version of the encryption program N. For example, the firmware F2 contains only the program segment A1 for the version number “1.0.” Similarly, the firmware F2 contains a program segment B1, . . . , N1 for each of the previous versions of the encryption program to the latest version. Note that the program segment N1 is that of the encryption program N.

The CM 110 loads the firmware F2 to the storage unit 130 (RAM 112) and runs the firmware F2. The control unit 170 searches the information on the firmware F2 stored in the storage unit 130 to find the program segment A1 corresponding to the version number “1.0” of the program segment A2 stored in the backup data storage unit 150. The control unit 170 restores the encryption program A by combining the program segments A1 and A2 (step ST2).

The control unit 170 decrypts the encrypted data E1 stored in the backup data storage unit 150 with the restored encryption program A to thereby obtain the configuration data C1 (step ST3). In this connection, the program segment A1 in the storage unit 130 is not illustrated in step ST3 of FIG. 11. The configuration data C1 is used for processing by the firmware F2. After the decryption at step ST3, the control unit 170 may delete the encryption program A from the storage unit 130.

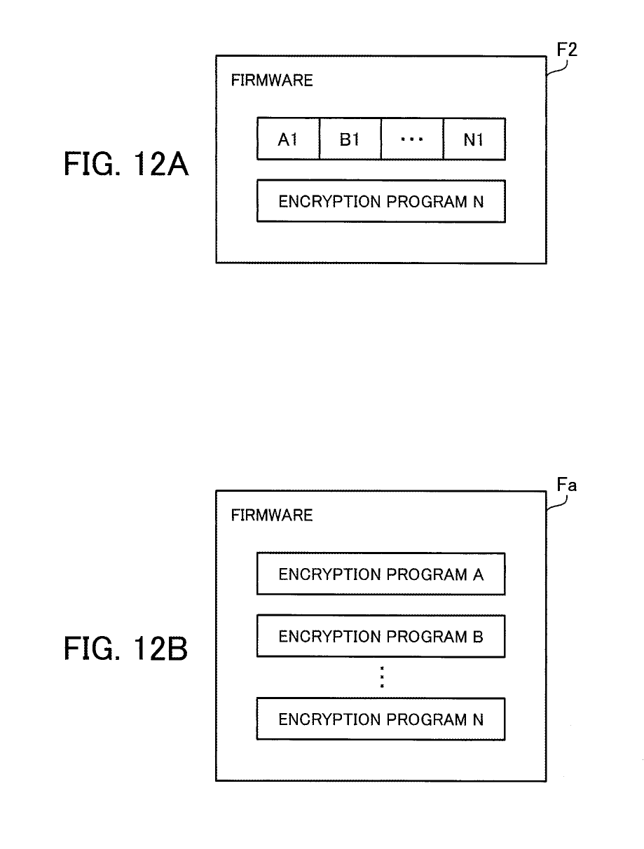

FIGS. 12A and 12B illustrate an example of firmware comparison. FIG. 12A exemplifies the firmware F2 to be used by the storage apparatus 100 of the second embodiment. FIG. 12B illustrates firmware Fa for comparison with the firmware F2. The firmware F2 contains only part of each of previous versions of the encryption program to the latest version. The firmware Fa contains all versions of the encryption program A, B, . . . , N in full.

The storage apparatus 100 of the second embodiment makes it possible to reduce the data size of firmware. For example, there is an idea that previous versions of the encryption program are included in full in new firmware. However, this idea increases the data size of the firmware each time the encryption program is updated.

In the storage apparatus 100, for example, only the program segment A1 of a previous version of the encryption program A is included in the new firmware F2. By doing so, it is possible to decrypt the encrypted data E1, which has been encrypted with the encryption program A, even after the update to the firmware F2. Therefore, the firmware F2 has a small data size, compared with the case where previous versions of the encryption program are included in full in the firmware F2.

Especially, it is so designed that a program segment (for example, program segment A2) to be obtained at the time of backup by the storage apparatus 100 is made larger than a program segment (for example, program segment A1) to be included in firmware. In other words, a program segment to be included in the firmware is made smaller than a program segment to be obtained at the time of backup by the storage apparatus 100. This further reduces the data size of the firmware.

Further, the encryption program A is not stored in full in the HDD of the DE 102. This reduces the risk that the third party gets the HDD and fraudulently obtains the contents of configuration data by decrypting encrypted data.

In the above description, the backup data storage unit 150 is provided in the HDD of the DE 102, 103. Alternatively, the backup data storage unit 150 may be provided in the flash memory 113 or a portable external storage medium, such as a magnetic tape or an optical disc. For example, a magnetic tape device built in the storage apparatus 100 or connected to the storage apparatus 100 or the server 200 may be usable. In this case, the encrypted data E1 and the segment table 151 may be stored in a magnetic tape inserted in the magnetic tape device.

### Third Embodiment

The following describes a third embodiment. Differential features from the above-described second embodiment will be described, and the same features will not be described.

In the second embodiment, an encryption program is divided into a former part and a latter part. Meanwhile, the third embodiment provides a function of dividing an encryption program into smaller sizes (hereinafter, referred to as blocks).

An information processing system of the third embodiment is the same as that of the second embodiment illustrated in FIG. 2. In addition, apparatuses and functions included in the information processing system of the third embodiment are the same as those of the second embodiment illustrated in FIGS. 2 to 5. Therefore, the same reference numerals and names of the second embodiment are applied in the third embodiment. However, different information from the second embodiment is registered in a management table and a segment table.

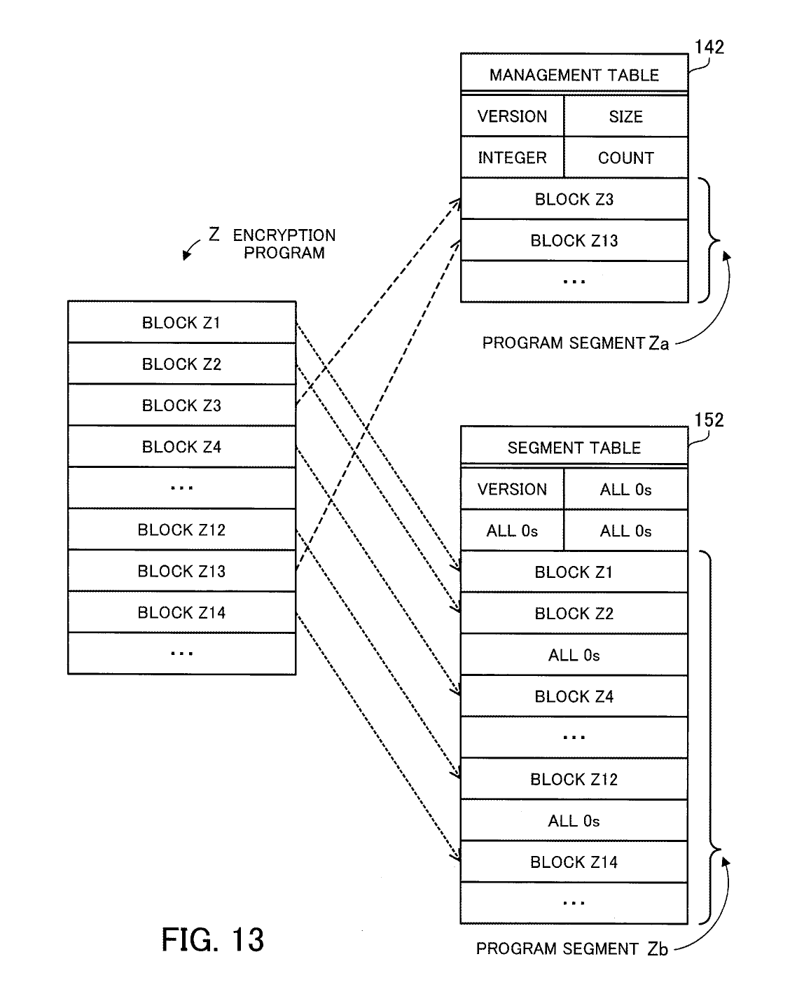

FIG. 13 illustrates an example of tables according to the third embodiment. A management table 142 is distributed together with firmware from a distribution unit 320, in place of the management table 141. A plurality of management tables 142 is prepared for individual versions and is stored together with firmware in a firmware storage unit 140.

The management table 142 includes information about version, size, integer, count, and program segment. The “version” field contains the same information as that of the management table 141.

The “size” field indicates the size (for example, 256 bytes) of one block. The “integer” field contains an integer. The “count” field indicates the number of blocks obtained by dividing an encryption program. A plurality of blocks is registered as a program segment.

A segment table 152 is stored in a backup data storage unit 150, in place of the segment table 151. The segment table 152 includes information about version and program segment. The “version” field contains the same information as that of the segment table 151. A plurality of blocks is registered as a program segment.

In this example, in the management table 142 and segment table 152, a program segment is registered in an area following an area for storing management information including version, size, integer, count, and others (information indicating the conditions for division). In this connection, the areas for size, integer, and count contain all “0”s in the segment table 152.

For example, an encryption program Z may be divided as follows. First, the encryption program Z is divided into blocks Z1, Z2, Z3, . . . . Then, a sequence K={k₁, k₂, k₃, . . . } is obtained using the version number m (m is an integer) and the integer n registered in the management table 142. In this connection, kᵢ=n×i+m (i is an integer) is calculated by incrementing i one by one, i=0, 1, 2, 3, . . . , until the smallest value kᵢ satisfying kᵢ≧α is obtained, where a denotes the count, indicating the number of blocks, registered in the management table 142. In the case where the version number m is “1.1” or the like, the version number may be rounded down to an integer like m=1 (may be rounded up or off to an integer).

For example, in the case of m=3 and n=10, a sequence K={3, 13, 23, 33, . . . } is obtained. Then, the distribution unit 320 stores the Kᵢ-th blocks from the first block as the elements of a program segment Za among the blocks Z1, Z2, Z3, . . . of the encryption program Z in the management table 142. For example, in the case of m=3 and n=10, the blocks Z3, Z13, Z23, . . . are registered in the management table 142.

Meanwhile, in this case, the control unit 170 registers the blocks Z1, Z2, Z4, . . . other than the blocks Z3, Z13, Z23, . . . as the elements of a program segment Zb in the segment table 152. The control unit 170 overwrites the parts corresponding to the blocks Z3, Z13, Z23, . . . of the program segment Zb (a part between the blocks Z2 and Z4 in the case of the block Z3) with dummy data (for example, with “0”s).

In this case, the control unit 170 is able to restore the encryption program Z by inserting the blocks registered in the management table 142 in the corresponding parts having the dummy data (dummy parts) of the program segment Zb registered in the segment table 152.

A processing procedure of the third embodiment will now be described. The following describes how a firmware distribution server 300 creates the management table 142.

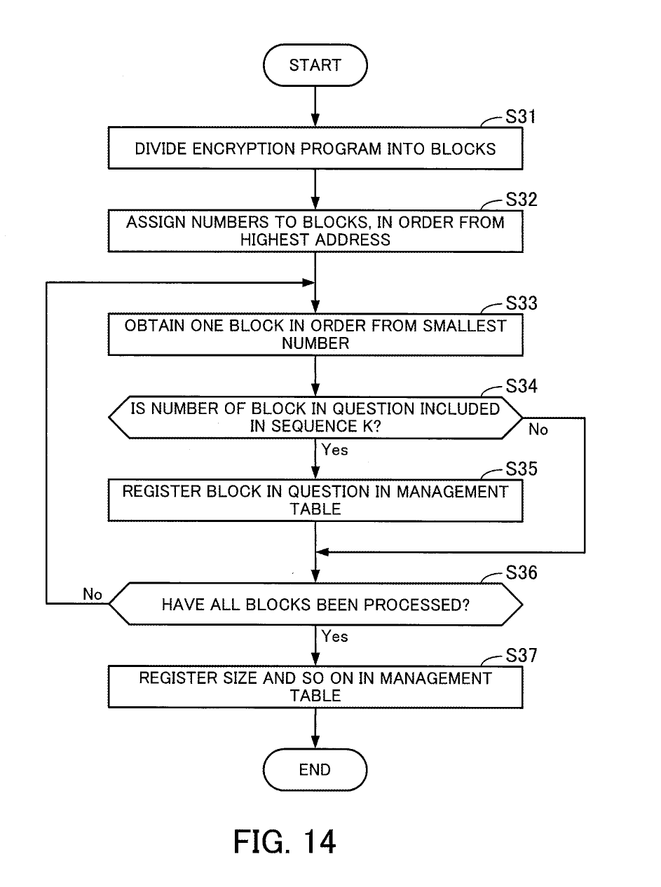

FIG. 14 is a flowchart illustrating an example of how to create a management table according to the third embodiment. The process of FIG. 14 will be described step by step. The firmware distribution server 300 performs the following process for each encryption program.

(S31) The distribution unit 320 divides an encryption program Z stored in the storage unit 310 into blocks. The block size is previously defined. The distribution unit 320 obtains blocks Z1, Z2, Z3, from the encryption program Z.

(S32) The distribution unit 320 assigns a number to each of the plurality of blocks obtained by dividing the encryption program Z, in order from the highest address of the storage unit 310. This numbering allows the distribution unit 320 to obtain the number of blocks, α. For example, a number “1” is assigned to the block Z1, and a number “2” is assigned to the block Z2. Numbers are assigned to the subsequent blocks in the same way.

(S33) The distribution unit 320 obtains one block in order from the smallest number. In the case of the encryption program Z, the distribution unit 320 obtains the block Z1 when step S33 is executed for the first time. Then, the distribution unit 320 obtains the block Z2 when step S33 is executed next time. The block obtained at step S33 is referred to as a “block in question.”

(S34) The distribution unit 320 determines whether the number of the block in question is included in the sequence K={k₁, k₂, k₃, . . . }. As described earlier, the distribution unit 320 is able to obtain each element of the sequence K through the calculation of kᵢ=n×i+m (i=0, 1, 2, 3, . . . ). If the number of the block in question is included in the sequence K, the process proceeds to step S35. Otherwise, the process proceeds to step S36.

(S35) The distribution unit 320 creates and stores a management table in the storage unit 310, and then registers the block in question therein.

(S36) The distribution unit 320 determines whether all of the blocks have been processed. If all of the blocks have been processed, the process proceeds to step S37. Otherwise, the process proceeds to step S33.

(S37) The distribution unit 320 registers the version number of the encryption program Z, the block size, the integer n, the number of blocks a in the management table stored in the storage unit 310.

As described above, the distribution unit 320 creates a management table for each of the latest and previous versions of the encryption program, and includes the created management tables in firmware. The distribution unit 320 also includes the latest version of the encryption program in full in the firmware. The following describes how the storage apparatus 100 performs encryption.

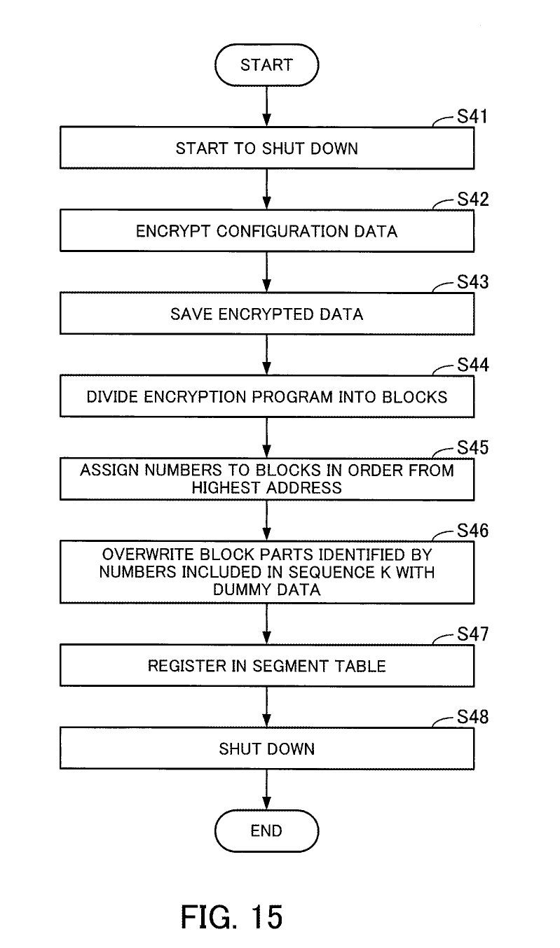

FIG. 15 is a flowchart illustrating an example of encryption according to the third embodiment. The process of FIG. 15 will be described step by step.

(S41) The CM 110 starts to shut down. The control unit 170 may control the shutdown of the CM 110.

(S42) The control unit 170 encrypts the configuration data stored in the storage unit 130 with the latest version of the encryption program included in the currently running firmware. It is now assumed that the encryption program Z is used for the encryption.

(S43) The control unit 170 stores the encrypted data in the backup data storage unit 150 (saves the encrypted data).

(S44) The control unit 170 divides the encryption program Z stored in the storage unit 130 into blocks. The size (for example, 256 kilobytes) registered in the management table is used as the block size. The control unit 170 obtains the blocks Z1, Z2, Z3, . . . from the encryption program Z.

(S45) The control unit 170 assigns a number to each of the plurality of blocks obtained by dividing the encryption program Z, in order from the highest address of the storage unit 130. This numbering allows the control unit 170 to obtain the number of blocks, a. For example, a number “1” is assigned to the block Z1, and a number “2” is assigned to the block Z2. Numbers are assigned to the subsequent blocks in the same way.

(S46) The control unit 170 overwrites the block parts identified by the numbers included in the sequence K={k₁, k₂, k₃, . . . } with dummy data (all “0”). As described earlier, the control unit 170 is able to obtain each element of the sequence K through the calculation of kᵢ=n×i+m (i=0, 1, 2, 3, . . . ). The control unit 170 obtains the value of the integer n (associated with the version number of the encryption program Z) with reference to the management table.

(S47) The control unit 170 generates a program segment Zb with dummy data inserted in the block parts identified by the numbers included in the sequence K of the encryption program Z. The control unit 170 registers the contents of the program segment Zb in association with the version number of the encryption program Z in the segment table 152.

(S48) The CM 110 completes its shutdown. In the case where the program for the firmware is updated, the shutdown is completed after the updated program for the firmware is stored in the firmware storage unit 140 in the flash memory 113.

As described above, when the CM 110 shuts down (power is turned off), the control unit 170 encrypts and saves the configuration data stored in the RAM 112 for backup. At this time, the control unit 170 registers the program segment Zb of the encryption program Z used for encrypting the configuration data in the segment table 152.

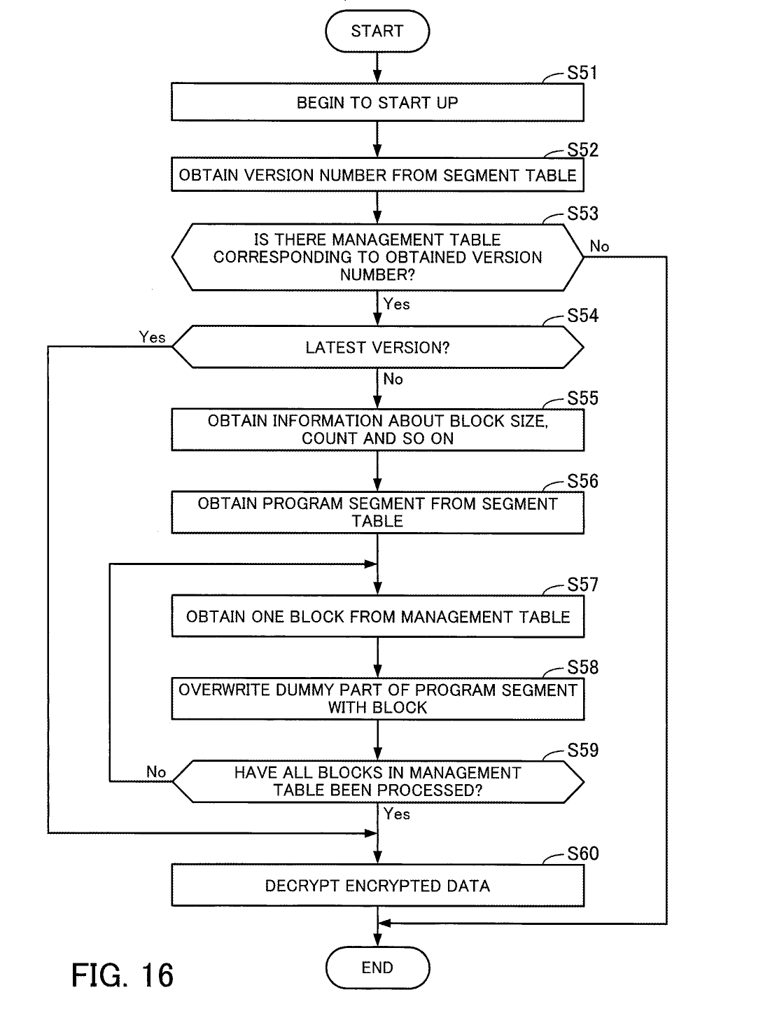

FIG. 16 is a flowchart illustrating an example of decryption according to the third embodiment. The process of FIG. 16 will be described step by step.

(S51) The CM 110 begins to start up. For example, the processor 111 loads a program describing the functions of the control unit 170 and the program for the firmware from the flash memory 113 to the RAM 112, and runs the loaded programs to implement the functions of the control unit 170 and the firmware on the CM 110. At this time, the program for the firmware read from the RAM 112 may be an updated version of the program for the firmware used at the time of the last shutdown. If so, the encryption program may also have been updated.

(S52) The control unit 170 obtains the version number associated with a program segment Zb. For example, the control unit 170 obtains the version number of the program segment Zb with reference to the segment table 152.

(S53) The control unit 170 determines whether there is a management table 142 corresponding to the version number obtained at step S52. The management table 142 corresponding to each version number has been loaded together with the firmware to the storage unit 130. If such a management table exists, the process proceeds to step S54. Otherwise, the process is completed. If the management table 142 corresponding to the version number obtained at step S52 does not exist, it means that it is not possible to decrypt the encrypted data stored in the backup data storage unit 150. In this case, the control unit 170 may notify the user of the error.

(S54) The control unit 170 determines whether the version number obtained at step S52 is the latest version. If it is the latest version, the process proceeds to step S60. Otherwise, the process proceeds to step S55. As described earlier, the latest version of the encryption program is included in full in the firmware. In the case where the encryption program Z is of the latest version, it means that the encryption program Z is included in full in the firmware loaded to the RAM 112.

(S55) The control unit 170 obtains information about the block size, integer, and count associated with the version number obtained at step S52 from the management table 142.

(S56) The control unit 170 obtains the program segment Zb from the segment table 152 and stores it in the RAM 112.

(S57) The control unit 170 obtains one block from the program segment Za of the management table 142 (one by one in order from the highest address of the storage unit 130). For example, when executing step S57 for the first time, the control unit 170 obtains the block Z3. Then, when executing step S57 next time, the control unit 170 obtains the block Z13.

(S58) The control unit 170 overwrites the corresponding dummy part of the program segment Zb stored in the RAM 112 with the block obtained at step S57 (the dummy parts are sequentially overwritten in order from the highest address).

(S59) The control unit 170 determines whether the dummy parts of the program segment Zb have been overwritten with all of the blocks registered in the management table 142. If all of the blocks have been processed (the dummy parts have been overwritten), the process proceeds to step S60. Otherwise, the process proceeds to step S57. The control unit 170 overwrites the dummy parts of the program segment Zb with all of the blocks to thereby restore the encryption program Z.

(S60) The control unit 170 decrypts the encrypted data stored in the backup data storage unit 150 with the encryption program Z to thereby obtain the configuration data.

As described above, the configuration data is obtained by restoring the encryption program Z and then decrypting the encrypted data. Thereby, the control unit 170 is able to control the storage apparatus 100 using the obtained configuration data.

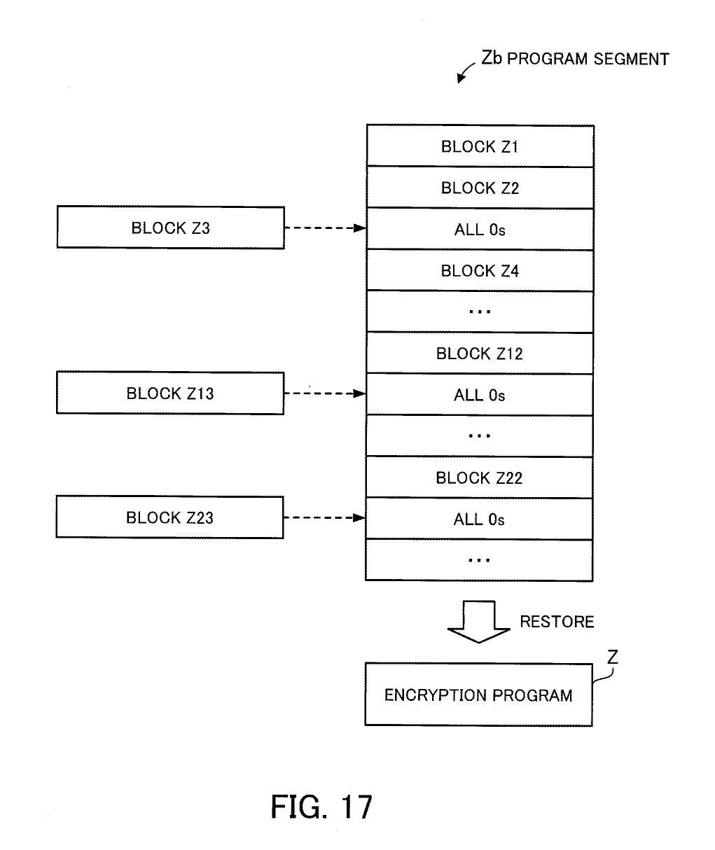

FIG. 17 illustrates a specific example of restoring an encryption program according to the third embodiment. In the program segment Zb, parts corresponding to the blocks Z3, Z13, Z23, . . . of the encryption program Z have been overwritten with dummy data (for example, all “0”s). The control unit 170 obtains the blocks Z3, Z13, Z23, . . . from the management table 142 and then overwrites the dummy parts of the program segment Zb with the obtained blocks to thereby restore the encryption program Z.

In this connection, dummy parts are provided in the program Zb. However, such dummy parts may not be provided. In this case, the blocks of the program segment Zb are arranged to follow one another without any dummy part inserted therebetween (for example, not a dummy part but the block Z4 follows the block Z2). This reduces the size of the program segment Zb. In addition, the control unit 170 is able to determine based on information registered in the management table 142 where to insert the blocks Z3, Z13, Z23, . . . in the program segment Zb.

For example, the address position for inserting the block Z3 in the RAM 12 is calculated by “the beginning address of block Z1+block size×(k₁−1).” The address position for the block Z4 is one block size after the calculated address position for the block Z3. After the insertion of the block Z3, the address position for inserting the block Z13 is calculated with “the beginning address of the block Z1+block size×(k₁₃−1).” The address positions for the subsequent blocks are calculated in the same way.

As described above, the storage apparatus 100 is able to obtain the encryption program Z by combining the program segments Za and Zb.

Similarly to the second embodiment, the storage apparatus 100 of the third embodiment makes it possible to reduce the data size of the control program. In addition, in the third embodiment, each program segment Za, Zb is generated by eliminating plural parts from the encryption program Z. This makes it difficult to restore the encryption program Z from the program segments Za and Zb without information about the block size and integer registered in the management table 142, compared with the second embodiment in which a program is divided into former and latter parts. Therefore, it is possible to reduce a risk of fraudulently restoring the encryption program Z without the information about the block size and integer registered in the management table 142 even if the program segments Za and Zb are obtained fraudulently.

In the above description, the backup data storage unit 150 is provided in the HDD of the DE 102, 103. Alternatively, the backup data storage unit 150 may be provided in the flash memory 113 or in a magnetic tape. For example, a magnetic tape device built in the storage apparatus 100 or connected to the storage apparatus 100 or the server 200 may be usable. In this case, encrypted data and the segment table 152 may be stored in a magnetic tape inserted in the magnetic tape device.

The information processing of the first embodiment may be implemented by causing a processor functioning as the operation unit 1b to run a program. The information processing of the second or third embodiment may be implemented by causing the processor 111 to run a program. Such a program may be recorded on a computer-readable recording medium (for example, recording medium 13). The CMs 110 and 120 each provided with a processor and RAM are one example of a computer.

To distribute the program, for example, recording media on which the program is recorded may be put on sale. Alternatively, the program may be stored in another computer and may be transferred from the other computer through a network. A computer may store (install) the program recorded on the recording medium or the program received from the other computer to a storage device, such as the flash memory 113, read the program from the storage device to the RAM 112, and then run the program.

According to one aspect, it is possible to reduce the data size of a control program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A storage control apparatus comprising:
a memory that stores a first control program to be used for controlling a storage apparatus, the first control program including an encryption program to be used for encrypting and decrypting data and version information indicating a version number of the encryption program; and
a processor that performs a process including:
storing, when backing up the data, encrypted data obtained by encrypting the data, a first part of the encryption program used for the encrypting, and the version information in a non-volatile storage medium;
obtaining, when reading the encrypted data from the non-volatile storage medium after the first control program is updated to a second control program, a second part of the encryption program corresponding to the version number indicated by the version information stored in the non-volatile storage medium from the second control program; and
generating the encryption program to be used for decrypting the encrypted data stored in the non-volatile storage medium, using the obtained second part and the first part stored in the non-volatile storage medium.

2. The storage control apparatus according to claim 1, wherein the storing includes obtaining the first part of larger size than the second part from the encryption program and storing the first part in the non-volatile storage medium.

3. The storage control apparatus according to claim 1, wherein the process further includes encrypting and decrypting configuration data to be used for processing by the first and second control programs, using the encryption program included in the first control program.

4. The storage control apparatus according to claim 1, wherein:
the storing includes obtaining the first part from the encryption program under prescribed conditions that are defined for each version number in the first control program; and
the generating includes generating the encryption program by combining the first part and the second part under the conditions that are defined for each version number in the second control program.

5. The storage control apparatus according to claim 1, wherein:
the storing includes obtaining, when the storage control apparatus stops operation, the first part from the encryption program and storing the first part in the non-volatile storage medium; and
the generating includes generating, when the storage control apparatus begins to operate after the first control program is updated to the second control program, the encryption program with reference to the second control program.

6. A non-transitory computer-readable storage medium storing a computer program that causes a computer to perform a process for controlling a storage apparatus, the process comprising:
obtaining a first control program to be used for controlling the storage apparatus, the first control program including an encryption program to be used for encrypting and decrypting data and version information indicating a version number of the encryption program;
storing, when backing up the data, encrypted data obtained by encrypting the data, a first part of the encryption program used for the encrypting, and the version information in a non-volatile storage medium;
obtaining, when reading the encrypted data from the non-volatile storage medium after the first control program is updated to a second control program, a second part of the encryption program corresponding to the version number indicated by the version information stored in the non-volatile storage medium from the second control program; and
generating the encryption program to be used for decrypting the encrypted data stored in the non-volatile storage medium, using the obtained second part and the first part stored in the non-volatile storage medium.
